(19) United States
(12) Patent Application Publication
(10) Pub. No.: US 2026/0056025 A1
(43) Pub. Date: Feb. 26, 2026

(54) METHOD FOR PROVIDING GROUP DRIVING NAVIGATION DISPLAY AND NAVIGATION DEVICE PERFORMING THE SAME

(71) Applicant: HYUNDAI AUTOEVER CORP., Seoul (KR)

(72) Inventors: Jin Young HAN, Seoul (KR); Jong Gon KIM, Seoul (KR); Young Seo KIM, Seoul (KR); Ye Won SEOL, Seoul (KR); Da Eun JOUNG, Seoul (KR)

(21) Appl. No.: 19/305,344

(22) Filed: Aug. 20, 2025

(30) Foreign Application Priority Data
Aug. 21, 2024 (KR) 10-2024-0111693

(51) Int. Cl. G01C 21/36; G01C 21/34; G06F 3/0481; G06F 3/04842

(52) U.S. Cl. CPC G01C 21/3626; G01C 21/3415; G06F 3/0481; G06F 3/04842

(57) ABSTRACT

Methods and devices for providing a group driving navigation display are described. In one embodiment, the method comprises displaying a driving route toward a common destination of a driving group that includes the navigation device and one or more peer navigation devices, detecting whether an estimated time of arrival (ETA) of at least one of the navigation device or the peer navigation devices is delayed more than a first reference value when compared to a required time of arrival for the common destination, and displaying a graphic object for transmitting delay-related communication for a communication device of the common destination in response to detecting that the ETA is delayed.

### CROSS-REFERENCE TO RELATED APPLICATION

This application claims priority from Korean Patent Application No. 10-2024-0111693 filed on Aug. 21, 2024, in the Korean Intellectual Property Office and all the benefits accruing therefrom under 35 U.S.C. 119, the contents of which in its entirety are herein incorporated by reference.

### BACKGROUND

### Technical Field

The present disclosure relates to a method for providing a group driving navigation display and a navigation device performing the same, and more particularly, to a method for providing a navigation display including information supporting group driving in accordance with an estimated time of arrival of members who are during group driving, and a navigation device performing the same.

### Description of the Related Art

In general, a navigation system equipped with a Global Positioning System (GPS) for checking a current location and a moving speed of a corresponding vehicle or determining the moving speed is used for various mobility devices. The navigation system receives radio waves indicating latitude, longitude, altitude, etc. from a plurality of artificial satellites, calculates the current location of the vehicle to identify the current location of the vehicle, identifies a destination input from a user, and determines a moving route starting from the current location and arriving at the destination.

When a plurality of users drive in a group toward a common destination, a technology for displaying information such as a location of the plurality of users who are during group driving and an estimated time of arrival on a navigation display is known. However, according to this related art, the users check only mutual locations during group driving, and there is still a lack of other services that can improve convenience of users who are during group driving.

### BRIEF SUMMARY

An object of the present disclosure is to provide a method for notifying a common destination of a delay situation and supporting adjustment of a reservation time, etc. when a delayed arrival is expected compared to the required time of arrival for the common destination during group driving.

Another object of the present disclosure is to provide a method for recommending a place that may be considered as a stopover when an early arrival is expected compared to the required time of arrival for a common destination during group driving.

The objects of the present disclosure are not limited to those mentioned above and additional objects of the present disclosure, which are not mentioned herein, will be clearly understood by those skilled in the art from the following description of the present disclosure.

According to an aspect of the present disclosure, there is provided a method for providing a group driving navigation display, which is performed by a navigation device. The method may comprise: displaying a driving route toward a common destination of a driving group that includes the navigation device and one or more peer navigation devices; detecting that an estimated time of arrival (ETA) of at least one of the navigation device or the peer navigation device is delayed at a first reference value or more compared to a required time of arrival for the common destination; and displaying a graphic object for transmitting delay-related communication for a communication device of the common destination in response to detecting that the estimated time of arrival is delayed.

In some embodiments, the required time of arrival for the common destination may be any one of a reservation time for the common destination and an average estimated time of arrival of the driving group.

In some embodiments, the displaying a graphic object may include determining whether to display the graphic object based on the number of delayed navigation devices detected as being delayed; and displaying the graphic object in response to determining that the graphic object is displayed.

In some embodiments, the determining whether to display the graphic object may include determining to display the graphic object when the number of delayed navigation devices is more than or equal to a majority and determining to display the graphic object when the number of delayed navigation devices is less than a majority.

In some embodiments, the determining whether to display the graphic object may include: identifying a type of the common destination when the number of delayed navigation devices is less than a majority; and determining to display the graphic object when the type of the common destination is included in a preset destination type, and determining not to display the graphic object when the type of the common destination is not included in the preset destination type.

In some embodiments, the displaying a graphic object may further include displaying a tag indicating delay information on the delayed navigation device detected as being delayed.

In some embodiments, the graphic object may include at least one of a first graphic object for triggering a phone connection to the common destination and a second graphic object for triggering a notification for an application that provides a reservation service.

In some embodiments, the method may further comprise displaying transmission information of the delay-related communication in response to selection of the graphic object.

In some embodiments, the transmission information of the delay-related communication may include information on whether the delay-related communication is in progress and information on a result of the delay-related communication.

According to the aforementioned and other embodiments of the present disclosure, there is provided a method for providing a group driving navigation display, which is performed by a navigation device. The method may comprise: displaying a driving route toward a common destination of a driving group that includes the navigation device and one or more peer navigation devices; detecting that an estimated time of arrival (ETA) of the navigation device is fast at a second reference value compared to a required time of arrival for the common destination; and displaying information on a recommended place in response to detecting that the estimated time of arrival is fast.

In some embodiments, the required time of arrival for the common destination may be any one of a reservation time for the common destination and an average estimated time of arrival of the driving group.

In some embodiments, the displaying information on a recommended place may include: displaying a screen asking whether information on the recommended place is confirmed; and displaying a screen including detailed information on at least one recommended place in response to a user selection to accept confirmation of the information on the recommended place.

In some embodiments, the displaying information on a recommended place may include: identifying a type of road currently being driven by a mobility device equipped with the navigation device; re-searching for a detour route toward a second type of road that is different from a first type of road when the type of road is the first type of road; and displaying information on at least one recommended place located within a preset distance from the re-searched route.

In some embodiments, the displaying information on a recommended place may include: determining whether a mobility device equipped with the navigation device is being stopped; and displaying a screen including detailed information on at least one recommended place when it is determined that the mobility device is being stopped.

In some embodiments, the recommended place may be selected by reflecting chat content related to the driving group.

In some embodiments, the method may further comprise displaying a route to the recommended place in response to a user selection for the recommended place.

According to the aforementioned and other embodiments of the present disclosure, there is provided a navigation device comprising: a processor; and a memory storing instructions. The instructions, when executed by the processor, may allow the processor to perform: an operation of displaying a driving route toward a common destination of a driving group that includes a navigation device and one or more peer navigation devices; an operation of detecting that an estimated time of arrival (ETA) of at least one of the navigation device or the peer navigation device is delayed at a first reference value or more compared to a required time of arrival for the common destination; and an operation of displaying a graphic object for transmitting delay-related communication for a communication device of the common destination in response to detecting that the estimated time of arrival is delayed.

In some embodiments, the operation of displaying a graphic object may include: an operation of determining whether to display the graphic object based on the number of delayed navigation devices detected as being delayed; and an operation of displaying the graphic object in response to determining that the graphic object is displayed.

In some embodiments, the operation of displaying a graphic object may further include an operation of displaying a tag indicating delay information on the delayed navigation device detected as being delayed.

In some embodiments, the instructions may allow the processor to further perform an operation of displaying transmission information of the delay-related communication in response to selection of the graphic object.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an exemplary view illustrating an environment in which a navigation device according to one embodiment of the present disclosure may be applied;

FIG. 2 is a flow chart illustrating a method for providing a group driving navigation display according to one embodiment of the present disclosure;

FIG. 3 is a flow chart illustrating a modified embodiment of some operations of the method for providing a group driving navigation display, which is described with reference to FIG. 2;

FIGS. 4 to 8 are exemplary views illustrating navigation displays that may be referenced in the embodiment of FIG. 2;

FIG. 9 is an exemplary flow chart illustrating a method for providing a driving group navigation display according to another embodiment of the present disclosure;

FIGS. 10 and 11 are exemplary views illustrating navigation displays that may be referenced in the embodiment of FIG. 9; and

FIG. 12 is a block diagram illustrating hardware configuration of a computing device for providing a group driving navigation display according to the embodiment of the present disclosure.

### DETAILED DESCRIPTION OF THE DISCLOSURE

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

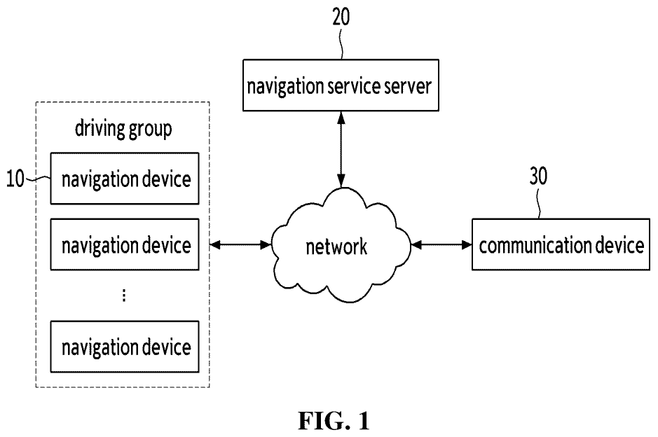

FIG. 1 is an exemplary view illustrating an environment in which a navigation device according to one embodiment of the present disclosure may be applied. As shown in FIG. 1, a plurality of navigation devices including a navigation device 10 may interact with a navigation service server 20 and a communication device 30 to implement a method for providing a group driving navigation display according to some embodiments of the present disclosure.

According to one embodiment of the present disclosure, the navigation device 10 may display information for supporting group driving or a graphic object including the information on a navigation display. For example, when it is detected that an estimated time of arrival (ETA) of at least one of the navigation device or a peer navigation device is delayed compared to the required time of arrival for a common destination, the navigation device 10 may display a graphic object for transmitting delay-related communication for the communication device 30 of the common destination on the navigation display. In another example, the navigation device 10 may display information on a recommended place on the navigation display in response to detecting that the estimated time of arrival (ETA) of the navigation device is fast at a second reference value or more compared to the required time of arrival for the common destination.

According to one embodiment of the present disclosure, the navigation service server 20 may perform a function of transmitting information or a command for supporting group driving to each driving group that includes a plurality of navigation devices including the navigation device 10. For example, the navigation service server 20 may transmit information on a driving route toward a common destination of the driving group. Also, the navigation service server 20 may transmit a command for displaying a graphic object for transmitting delay-related communication for the communication device 30 of the common destination to at least one of the navigation devices in response to detecting that the estimated time of arrival (ETA) of at least one of the navigation devices is delayed at a first reference value or more compared to the required time of arrival for the common destination.

In another example, the navigation service server 20 may transmit a command for displaying information on a recommended place to at least one navigation device detected as being the fastest among the plurality of navigation devices in response to detecting that the estimated time of arrival of at least one of the plurality of navigation devices is fast at a second reference value or more compared to the required time of arrival for the common destination.

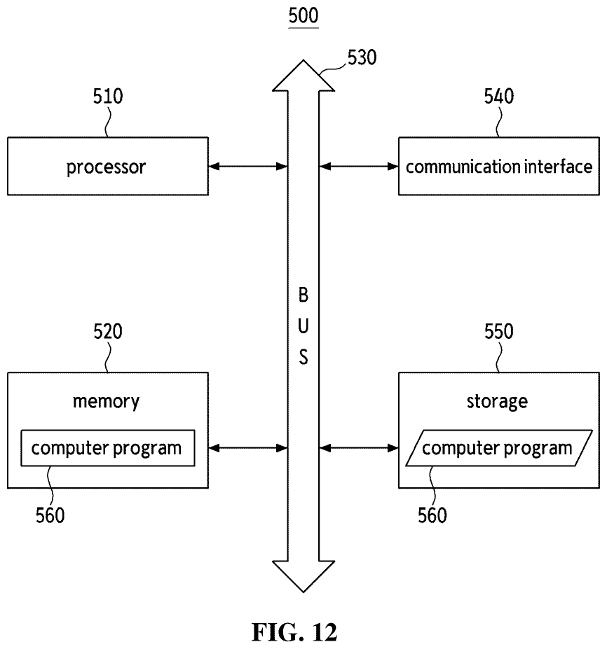

The navigation device 10, the navigation service server 20 and the communication device 30 according to the embodiment of the present disclosure may be implemented on at least one computing device. For example, all functions of the navigation device 10 may be implemented in one computing device, some functions of the navigation device 10 may be implemented in a first computing device, and other functions of the navigation device 10 may be implemented in a second computing device. Alternatively, a specific function of the navigation device 10 may be implemented in a plurality of computing devices. The computing device may include an arbitrary device provided with both a computation means and a communication means, and the embodiment in which the navigation device 10 is implemented as a computing device will be described in more detail with reference to FIG. 12.

In addition, the components shown in FIG. 1 may communicate with each other through a network. For example, the network may be implemented as all kinds of wired/wireless networks such as a local area network (LAN), a wide area network (WAN), a mobile radio communication network and a wireless broadband Internet (Wibro). Furthermore, the navigation device 10, the navigation service server 20 and the communication device 30, which are shown in FIG. 1, may constitute a single computing system that communicates through the network.

The exemplary environment in which the method for providing a group driving navigation display according to some embodiments of the present disclosure may be performed has been described with reference to FIG. 1. The embodiments described above will be understood in more detail with reference to other embodiments that will be described later. In addition, the technical spirits that may be understood through the above-described embodiments may be reflected in other embodiments that will be described later, even though not specified separately.

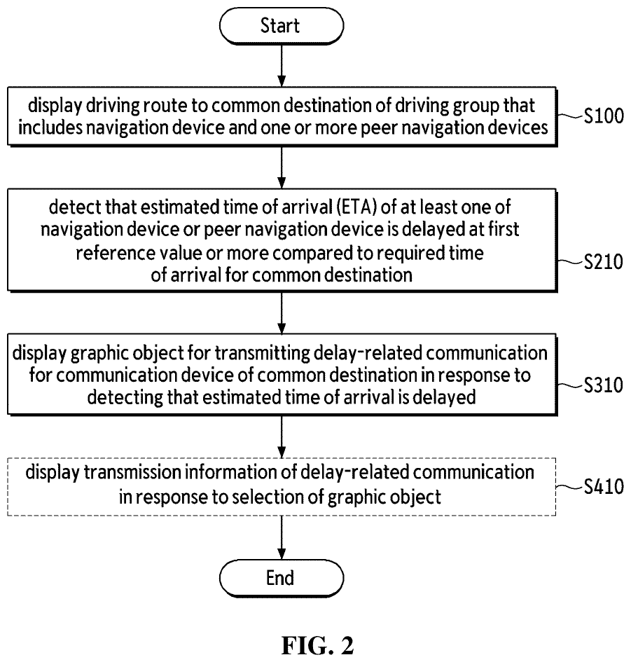

Hereinafter, the method for providing a group driving navigation display according to some embodiments of the present disclosure will be described in detail with reference to FIG. 2 and subsequent drawings. The method for providing a group driving navigation display, which will be described below, may be performed by at least one computing device. At least one computing device may be the navigation device 10 and/or the navigation service server 20. That is, all steps/operations of the method for providing a group driving navigation display, which will be described below, may be performed by the navigation device 10 or the navigation service server 20, some steps/operations may be performed by the navigation device 10, and some other steps/operations may be performed by the navigation service server 20.

Hereinafter, for convenience of understanding, the description will be continued on the assumption that the navigation device 10 plays a leading role. Therefore, when the subject of a specific step/operation is omitted, it may be understood that the specific step/operation is performed by the navigation device 10. However, even though the subject of the specific step/operation is referred to as the navigation device 10, the navigation service server 20 may perform the specific step/operation in accordance with the implementation method, aspect, and the like.

FIG. 2 is a flow chart illustrating a method for providing a group driving navigation display according to one embodiment of the present disclosure. However, this is only a preferred embodiment for achieving the object of the present disclosure, and some steps may be added or deleted as necessary. Also, for convenience of description, the description of the operation subject of each step may be omitted.

As shown in FIG. 2, the method for providing a group driving navigation display according to one embodiment of the present disclosure may start in step S100 in which a driving route toward a common destination of a driving group, which includes a navigation device and one or more peer navigation devices, is displayed. In detail, a route from a current location of a mobility device equipped with a navigation device to a common destination of a driving group may be displayed, and a location of a peer mobility device equipped with each peer navigation device may be displayed on a map.

In one embodiment, a driving group widget including information on a navigation device belonging to a driving group, that is, a member belonging to the driving group may be displayed on a region of the navigation display. Identifiers (icons, photos, characters, nicknames, etc.) of members belonging to the driving group may be displayed on the driving group widget, and information on an estimated time of arrival, delay information, transmission information of delay-related communication, etc. of each member may be displayed on a region corresponding to each identifier.

Next, in step S210, it may be detected that the estimated time of arrival (ETA) of at least one of the navigation device or the peer navigation device is delayed at a first reference value or more compared to the required time of arrival for the common destination. Information on the estimated time of arrival of each of a plurality of navigation devices (i.e., the navigation device and one or more peer navigation devices) belonging to the driving group may be obtained during a route search for the common destination or in real time, and when the estimated time of arrival of at least one of the navigation devices is delayed at the first reference value or more compared to the required time of arrival for the common destination, information on the delayed navigation device may be obtained. The required time of arrival for the common destination may be any one of a reservation time for the common destination and an average estimated time of arrival of the driving group. The average estimated time of arrival of the driving group may be calculated using information on the estimated time of arrival of the plurality of navigation devices and information on the number of the plurality of navigation devices (i.e., the number of members belonging to the driving group). The first reference value may be determined in accordance with a type of the common destination, or may be previously set by a user or automatically set in the system. For example, the first reference value may represent a time of 15 minutes.

Next, in step S310, in response to detecting that the estimated time of arrival of at least one of the navigation device or the peer navigation device is delayed at the first reference value or more compared to the required time of arrival for the common destination, a graphic object for transmitting delay-related communication for the communication device of the common destination may be displayed. When the estimated time of arrival is delayed compared to the required time of arrival for the common destination, appropriate measures such as notifying the common destination of the delay situation and adjusting a reservation time will be required. Accordingly, in the present embodiment, when delay occurs, a graphic object for transmitting delay-related communication (i.e., information on the delay situation, information related to time adjustment) for the communication device of the common destination may be displayed. In this case, the graphic object may be displayed on the aforementioned driving group widget.

It may be more desirable not to transmit delay-related communication for the common destination in a situation that delay of a small number of members of the driving group is expected. Accordingly, in the present embodiment, whether to display a graphic object may be determined based on the number of delayed navigation devices detected as being delayed, and in response to determining that the graphic object is displayed, the graphic object may be displayed.

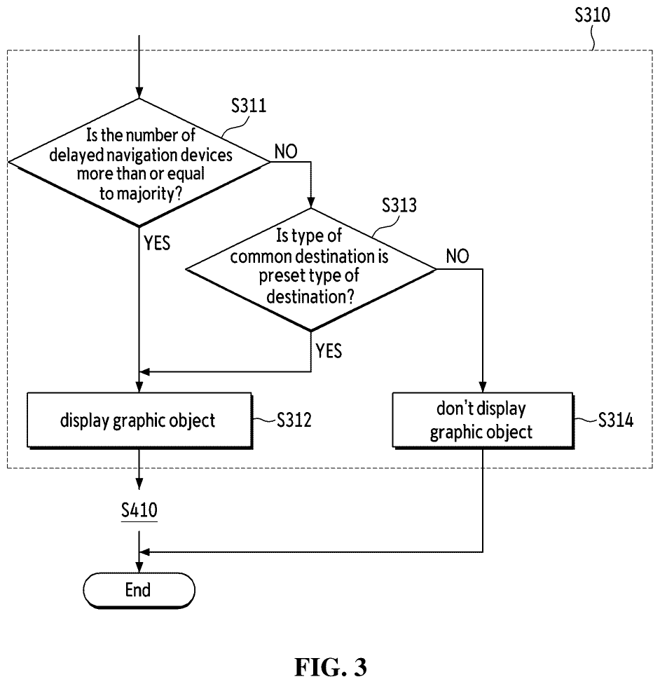

FIG. 3 is a flow chart illustrating a modified embodiment of some operations of the method for providing a group driving navigation display, which is described with reference to FIG. 2.

Referring to FIG. 3, when it is detected that the estimated time of arrival of at least one of the navigation device or the peer navigation device is delayed at a first reference value or more compared to the required time of arrival for the common destination (S210), it is determined whether the number of delayed navigation devices detected as being delayed is more than a majority (S311). That is, it is determined whether the majority of all members belonging to the driving group is expected to be delayed. In this case, when the number of delayed navigation devices is more than a majority (YES), it may be determined that the graphic object is displayed, and accordingly, the graphic object may be displayed (S312).

On the other hand, when the number of delayed navigation devices is less than a majority (NO), it may be further determined whether the type of the common destination is included in a preset destination type (S313). As a result of the determination, when the type of the common destination is included in the preset destination type (YES), it is determined that the graphic object is displayed (S312), and when the type of the common destination is not included in the preset destination type (NO), it may be determined that the graphic object is not displayed (S314). The preset destination type is a place that transmits a situation in which delay has occurred and requires a measure of time adjustment such as a reservation change, and may be, for example, a lodging facility such as a hotel, a restaurant, a cafe, etc.

When it is detected that the navigation device is delayed, it is necessary to display delay information so that information on the delay may be recognized by the members/colleagues of the driving group. In one embodiment, a tag indicating delay information on the delayed navigation device detected as being delayed may be displayed. For example, when the number of delayed navigation devices detected as being delayed is more than or equal to a majority, a “majority delay” tag indicating that more than a majority of the navigation devices are being delayed may be displayed. In another example, when the number of delayed navigation devices detected as being delayed is less than a majority, a “delay” tag indicating that some navigation devices (i.e., members) are being delayed may be displayed.

Referring back to FIG. 2, when a user input for selecting a graphic object is received, transmission information of delay-related communication may be displayed in response to the selection of the graphic object. The transmission information of delay-related communication may include information on whether the delay-related communication is in progress and information on the result of the delay-related communication. In detail, when the user input for selecting a graphic object is received for any one of a plurality of navigation devices belonging to a driving group, information indicating that delay-related communication is in progress may be displayed in a region displaying information of the corresponding navigation device. In this case, a graphic object that supports notifying members of the driving group of the result of the delay-related communication may be displayed together on the navigation display. When a graphic object for supporting the provision of information related to the result of the delay-related communication is selected, information on the result of the delay-related communication may be displayed.

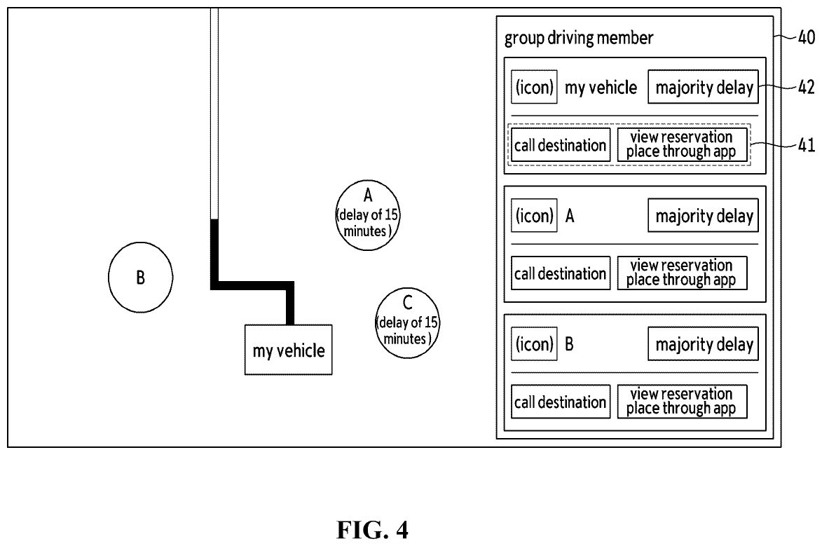

Hereinafter, a navigation display according to the method for providing a driving group navigation display according to the present embodiment will be described through various examples with reference to FIGS. 4 to 8.

FIGS. 4 to 8 are exemplary views illustrating navigation displays that may be referenced in the embodiment of FIG. 2.

FIG. 4 exemplarily illustrates a navigation display when the number of delayed navigation devices is more than or equal to a majority. As shown in FIG. 4, a route toward a common destination may be displayed in one region of the navigation display based on a location of “my vehicle”, and locations of pee vehicles A, B and C may be displayed. In addition, a driving group widget 40 including information on a group driving member is displayed in another region of the navigation display. Driving-related information of members A, B and C belonging to the driving group including “my vehicle” may be displayed on the driving group widget 40, respectively.

In FIG. 4, when delay occurs in the vehicles A and C, information indicating that the vehicle detected as being delayed has been delayed may be displayed on the map. Also, a graphic object 41 for transmitting delay-related communication for the communication device of the common destination may be displayed on the driving group widget 40. In this case, the graphic object 41 may include a first graphic object for triggering a phone connection to a common destination and a second graphic object for triggering a notification for an application that provides a reservation service, but the present embodiment is not limited thereto. When there is another means capable of notifying a delay situation for a common destination, a graphic object for triggering this means may be displayed.

Also, when the number of delayed navigation devices is more than or equal to a majority, it may be confirmed that the “majority delay” tag 42 indicating that more than a majority are delayed is displayed. In this case, the “majority delay” tag 42 may be displayed for all of the members belonging to the driving group. That is, the “majority delay” tag 42 may be displayed for each region in which the driving information of the members is displayed.

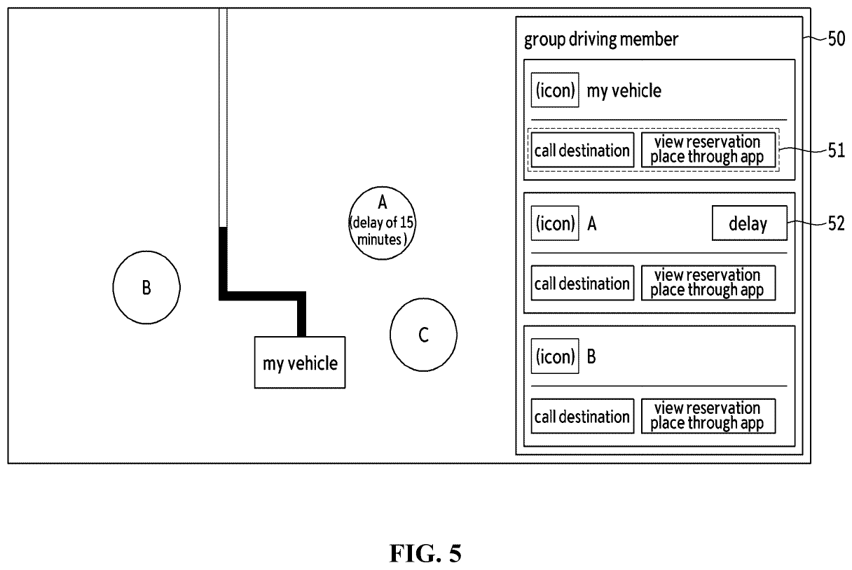

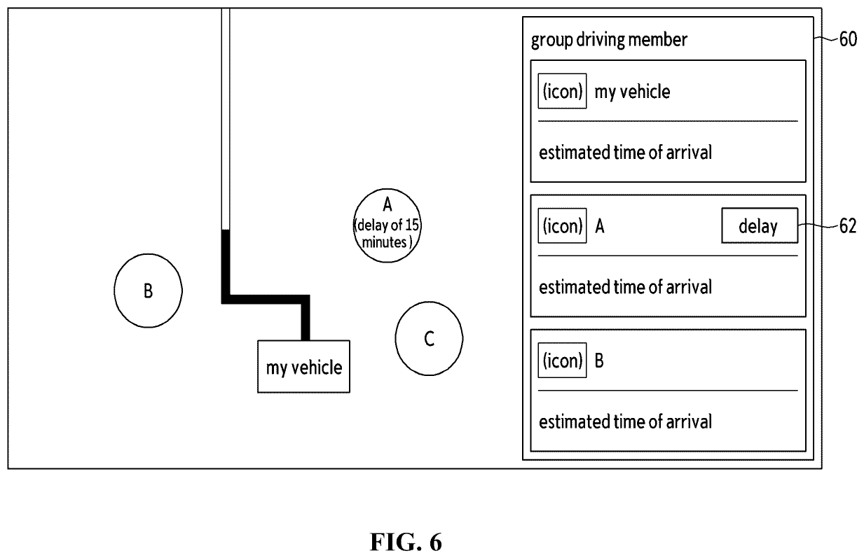

FIGS. 5 and 6 exemplarily illustrate a navigation display when the number of delayed navigation devices is less than a majority.

When the number of delayed navigation devices is less than a majority, and the common destination is included in the preset destination type, a graphic object 51 for transmitting delay-related communication for the communication device of the common destination may be displayed on the driving group widget 50 as shown in FIG. 5. In addition, a “delay” tag 52 may be displayed for a region in which driving information of the member A detected as being delayed is displayed.

When the number of delayed navigation devices is less than a majority, and the common destination is not included in the preset destination type, as shown in FIG. 6, a graphic object for transmitting delay-related communication for the communication device of the common destination is not displayed, and only a “delay” tag 62 may be displayed for a region in which driving information of the member A detected as being delayed is displayed.

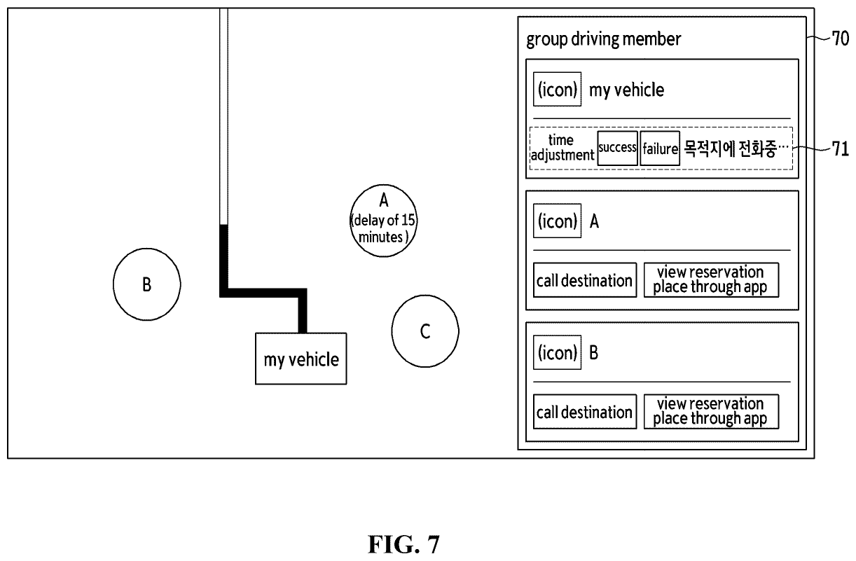

FIG. 7 exemplarily illustrates a navigation display when a graphic object is selected in the example described in FIG. 6.

As shown in FIG. 7, when the graphic object for transmitting delay-related communication for the communication device of the common destination is selected, transmission information of delay-related communication may be displayed in a region in which the graphic object is displayed. In detail, information indicating that delay-related communication for the common destination is in progress, such as “calling destination”, may be displayed as text on a region, in which information of a member (i.e., a member who is in progress of delay-related communication) who selects the graphic object is displayed, in the driving group widget 70, and a graphic object (“success”, “failure” 71) capable of selecting a result of delay-related communication may be displayed. Accordingly, the progress of delay-related communication may be confirmed.

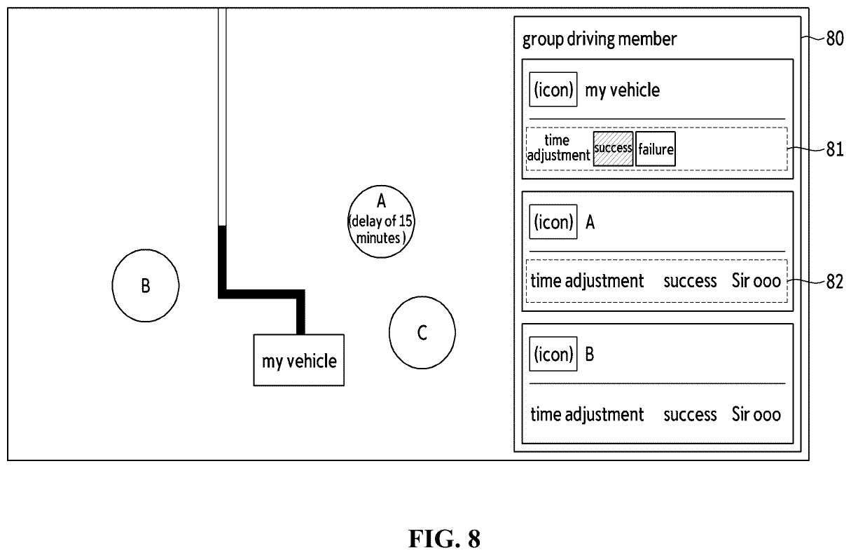

As shown in FIG. 8, when a graphic object representing “success” is selected after delay-related communication is completed (81), information indicating the result of delay-related communication, such as “success of time adjustment”, may be displayed on a region, in which information of another member other than the subject of delay-related communication is displayed.

As described above, according to the present embodiment, measures such as time adjustment may be quickly and conveniently performed in a situation that delay occurs for some of the members of the driving group headed for the common destination, thereby improving user convenience.

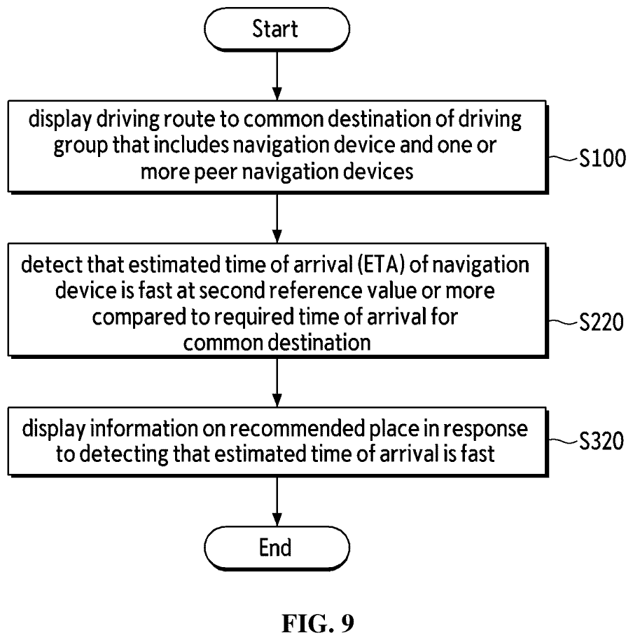

There may be a case that an estimated time of arrival of a member is faster than that of other member depending on a departure location, traffic conditions, etc., and in this case, it is necessary to provide information useful for spending time until the other member arrives. Hereinafter, an embodiment in which information on a recommended place is provided when an estimated time of arrival of a member is faster than that of the other member during group driving will be described in detail with reference to FIGS. 9 to 11.

FIG. 9 is an exemplary flow chart illustrating a method for providing a driving group navigation display according to another embodiment of the present disclosure. However, this is only a preferred embodiment for achieving the object of the present disclosure, and some steps may be added or deleted as necessary. For reference, the redundant description of the contents described in the previous embodiment will be omitted.

First, in step S100, a driving route toward a common destination of a driving group, which includes a navigation device and one or more peer navigation devices, may be displayed. In detail, a route from a current location of a mobility device equipped with a navigation device to the common destination of the driving group may be displayed, and a location of a peer mobility device equipped with each peer navigation device may be displayed on a map.

Next, in step S210, it may be detected that the estimated time of arrival (ETA) of the navigation device is fast at a second reference value or more compared to the required time of arrival for the common destination. The required time of arrival for the common destination may be any one of a reservation time for the common destination and an average estimated time of arrival of the driving group. In addition, the second reference value may be, for example, a time of 1 hour, but the present embodiment is not limited thereto. The second reference value may be set in consideration of a type of the common destination and a type of a recommended place.

Next, in step S320, in response to detecting that the estimated time of arrival of the navigation device is fast at the second reference value or more compared to the required time of arrival for the common destination, information on the recommended place may be displayed.

In detail, when it is detected that the estimated time of arrival of the navigation device is fast compared to the required time of arrival for the common destination, a screen asking whether information on the recommended place is confirmed may be displayed, and a screen including detailed information on at least one recommended place may be displayed in response to a user selection to accept confirmation of the information on the recommended place. In this case, for safety of a user, the screen including the detailed information on at least one recommended place may be displayed when it is determined that the mobility device equipped with the navigation device is being stopped.

In addition, at least one recommended place is located within a preset distance from the route toward the common destination, and may be selected in consideration of user activity information (e.g., visit information, evaluation information, favorite information, point of interest information, keyword information, etc.) or environment information (e.g., current time information, date information, weather information, season information, location information, etc.). In one embodiment, the recommended place may be selected by reflecting chat content related to the driving group. When there is a place mentioned in the chat content between members (users) belonging to the driving group, information on the corresponding place may be displayed.

When the mobility device equipped with the navigation device is currently driving on a highway, it may be difficult to select a recommended place around the route that is currently set. Accordingly, in the present embodiment, when a road on which the mobility device equipped with the navigation device is currently driving is a highway, an operation of re-searching a route may be performed prior to selecting/providing a recommended place. In detail, when the mobility device equipped with the navigation device checks a type of a road on which the mobility device equipped with the navigation device is currently driving, and when the type of the road is a first type of road (i.e., a highway), a detour route to a second type of road (a general road) may be re-searched, and information on at least one recommended place located within a preset distance from the re-searched route may be displayed.

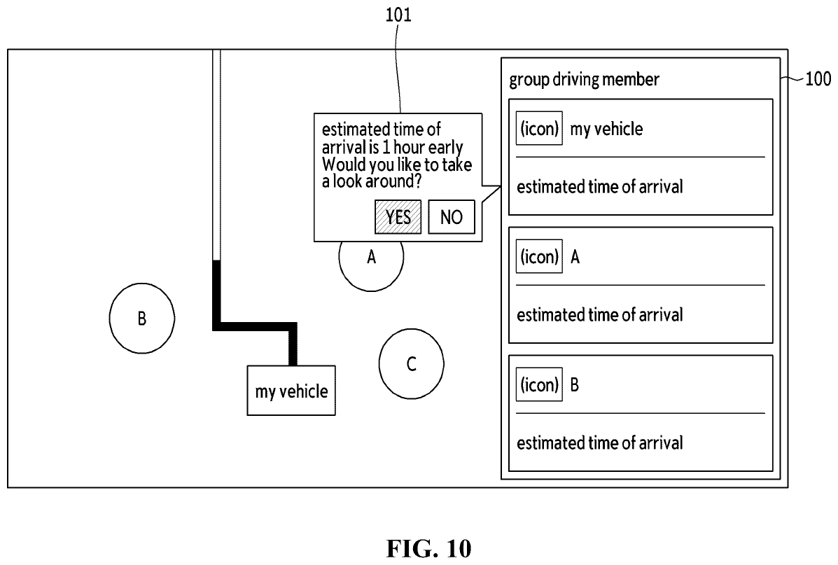

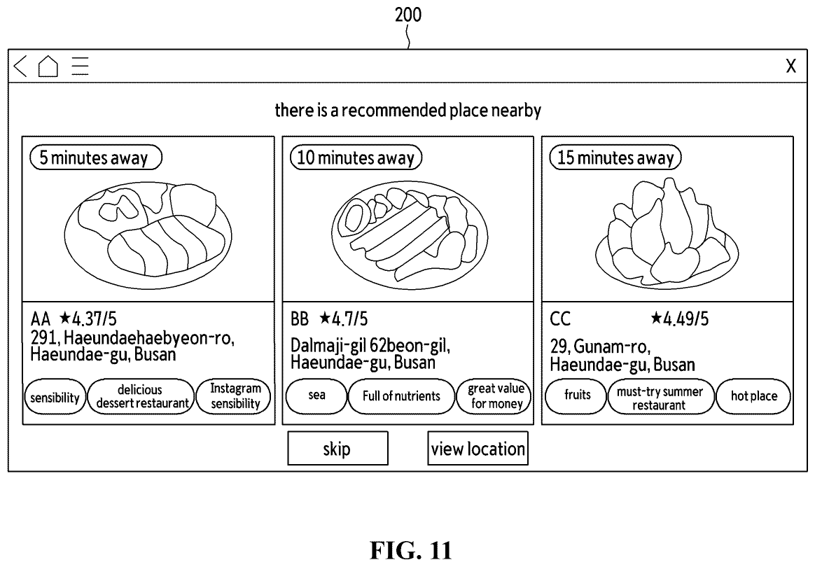

Hereinafter, a navigation display according to the method for providing a driving group navigation display according to the present embodiment will be described through various examples with reference to FIGS. 10 and 11.

FIGS. 10 and 11 are exemplary views illustrating navigation displays that may be referenced in the embodiment of FIG. 9.

FIG. 10 exemplarily illustrates that a screen asking whether information on a recommended place is confirmed is displayed when it is detected that the estimated time of arrival of the navigation device is fast compared to the required time of arrival for the common destination. As shown in FIG. 10, a pop-up screen asking whether information on a recommended place is confirmed is displayed, such as “An estimated arrival is 1 hour early. Would you like to take a look around?”, “Yes”, or “No.” When a user selects the “Yes” object, a screen, on which detailed information on a recommended place is displayed, is provided, and when the user selects the “No” object, the pop-up screen is removed.

FIG. 11 exemplarily illustrates a screen 200 including detailed information on at least one recommended place, which is displayed when the “Yes” object is selected, in the example described in FIG. 10.

As shown in FIG. 11, information such as image, name, address, keyword, and distance of at least one recommended place may be displayed as detailed information of the recommended place. At this time, when “skip” is selected, the screen 200 is removed, and when “view location” is selected, the location of each recommended place is displayed on the map display of FIG. 10, and a route including the recommended place is displayed in response to selecting any one recommended place.

The methods according to the embodiment of the present disclosure described as above may be performed by execution of a computer program implemented with computer-readable code. The computer program may be transmitted from the first computing device to the second computing device through a network such as the Internet and installed in the second computing device, thereby being used in the second computing device.

FIG. 12 is a block diagram illustrating hardware configuration of a computing device for providing a group driving navigation display according to the embodiment of the present disclosure. Referring to FIG. 12, the computing device 500 may include one or more processors 510, a bus 530, a communication interface 540, a memory 520 that loads a computer program executed by the processor 510, and a storage 550 that stores the computer program 560. However, only components related to the embodiments of the present disclosure are illustrated in FIG. 12. Accordingly, it may be understood by those skilled in the art that other general-purpose components may be further provided in addition to the components shown in FIG. 12. That is, the computing device 500 may further include various components in addition to the components shown in FIG. 12. In addition, in some cases, the computing device 500 may be configured in a form in which some of the components shown in FIG. 12 are omitted. Hereinafter, each component of the computing device 500 will be described.

The processor 510 may control the overall operation of each component of the computing device 500. The processor 510 may include at least one of a central processing unit (CPU), a micro processor unit (MPU), a micro controller unit (MCU), a graphic processing unit (GPU), or any type of processor well known in the technical field of the present disclosure. In addition, the processor 510 may perform computation on at least one application or program for executing an operation/method according to the embodiments of the present disclosure. The computing device 500 may include one or more processors.

Next, the memory 520 may store various types of data, commands, and/or information. The memory 520 may load the computer program 560 from the storage 550 to execute the operation/method according to the embodiments of the present disclosure. The memory 520 may be implemented as a volatile memory such as RAM, but the present disclosure is not limited thereto.

Next, the bus 530 may provide a communication function between components of the computing device 500. The bus 530 may be implemented as various types of buses such as an address bus, a data bus, and a control bus.

Next, the communication interface 540 may support wired/wireless Internet communication of the computing device 500. Also, the communication interface 540 may support various communication methods other than Internet communication. To this end, the communication interface 540 may be configured to include a communication module well known in the technical field of the present disclosure.

Next, the storage 550 may non-temporarily store one or more computer programs 560. The storage 550 may include a nonvolatile memory, such as a read only memory (ROM), an erasable programmable ROM (EPROM), and an electrically erasable programmable ROM (EEPROM) and a flash memory, a hard disk, a detachable disk, or any type of computer-readable recording medium well known in the art to which the present disclosure pertains.

Next, the computer program 560 may include one or more instructions that cause the processor 510 to perform the operation/method according to various embodiments of the present disclosure when loaded into the memory 520. That is, the processor 510 may perform the operation/method according to various embodiments of the present disclosure by executing one or more loaded instructions.

For example, the computer program 560 may include instructions to perform an operation of displaying a driving route toward a common destination of a driving group that includes a navigation device and one or more peer navigation devices, an operation of detecting that an estimated time of arrival (ETA) of at least one of the navigation device or the peer navigation device is delayed at a first reference value or more compared to the required time of arrival for the common destination, and an operation of displaying a graphic object for transmitting delay-related communication for a communication device of the common destination in response to detecting that the estimated time of arrival is delayed.

For another example, the computer program 560 may include instructions to perform an operation of displaying a driving route toward a common destination of a driving group that includes the navigation device and one or more peer navigation devices, an operation of detecting that an estimated time of arrival (ETA) of the navigation device is fast at a second reference value compared to the required time of arrival for the common destination, and an operation of displaying information on a recommended place in response to detecting that the estimated time of arrival is fast.

So far, a variety of embodiments of the present disclosure and the effects according to embodiments thereof have been mentioned with reference to FIGS. 1 to 12. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for providing a group driving navigation display, which is performed by a navigation device, the method comprising:
displaying a driving route toward a common destination of a driving group that includes the navigation device and at least one peer navigation device;
detecting whether an estimated time of arrival (ETA) of at least one of the navigation device and the at least one peer navigation device is delayed more than a first reference value when compared to a required time of arrival for the common destination; and
displaying a graphic object for transmitting delay-related communication for a communication device of the common destination in response to detecting that the ETA is delayed.

2. The method of claim 1, wherein the required time of arrival for the common destination is a reservation time for the common destination or an average estimated time of arrival of the driving group.

3. The method of claim 1, wherein the displaying of the graphic object includes:
determining whether to display the graphic object based on a number of the navigation device and the at least one peer navigation device detected as being delayed; and
displaying the graphic object in response to determining that the graphic object is displayed.

4. The method of claim 3, wherein the determining whether to display the graphic object includes determining the number of the navigation device and the at least one peer navigation device detected as being delayed and determining to display the graphic object when the number is less than a majority.

5. The method of claim 4, wherein the determining whether to display the graphic object includes:
identifying a type of the common destination when the number is less than the majority; and
determining to display the graphic object when the type of the common destination is included in a preset destination type, and determining not to display the graphic object when the type of the common destination is not included in the preset destination type.

6. The method of claim 1, wherein the displaying of the graphic object further includes displaying a tag indicating delay information on any of the navigation device and the at least one peer navigation device detected as being delayed.

7. The method of claim 1, wherein the graphic object includes a first graphic object for triggering a phone connection to the common destination or a second graphic object for triggering a notification for an application that provides a reservation service.

8. The method of claim 1, further comprising displaying transmission information of the delay-related communication in response to selection of the graphic object.

9. The method of claim 8, wherein the transmission information of the delay-related communication includes information on whether the delay-related communication is in progress and information on a result of the delay-related communication.

10. A method for providing a group driving navigation display, which is performed by a navigation device, the method comprising:
displaying a driving route toward a common destination of a driving group that includes the navigation device and at least one peer navigation device;
detecting that an estimated time of arrival (ETA) of the navigation device is fast at a second reference value compared to a required time of arrival for the common destination; and
displaying information on a recommended place in response to detecting that the ETA is fast.

11. The method of claim 10, wherein the required time of arrival for the common destination is a reservation time for the common destination or an average estimated time of arrival of the driving group.

12. The method of claim 10, wherein the displaying information on the recommended place includes:
displaying a first screen asking whether the information on the recommended place is confirmed; and
displaying a second screen including detailed information on at least one recommended place in response to a user selection to accept confirmation of the information on the recommended place.

13. The method of claim 10, wherein the displaying information on the recommended place includes:
identifying a type of road currently being driven by a mobility device equipped with the navigation device;
searching for a detour route toward a second type of road that is different from the type of road; and
displaying information on at least one recommended place located within a preset distance from the detour route.

14. The method of claim 10, wherein the displaying information on the recommended place includes:
determining whether a mobility device equipped with the navigation device is being stopped; and
displaying a screen including detailed information on at least one recommended place when it is determined that the mobility device is being stopped.

15. The method of claim 10, wherein the recommended place is selected by reflecting a chat content related to the driving group.

16. The method of claim 10, further comprising displaying a route to the recommended place in response to a user selection for the recommended place.

17. A navigation device comprising:
a processor; and
a memory storing instructions,
wherein the instructions, when executed by the processor, cause the processor to perform:
an operation of displaying a driving route toward a common destination of a driving group that includes the navigation device and at least one peer navigation device;
an operation of detecting whether an ETA of at least one of the navigation device and the at least one peer navigation device is delayed more than a first reference value when compared to a required time of arrival for the common destination; and
an operation of displaying a graphic object for transmitting delay-related communication for a communication device of the common destination in response to detecting that the ETA is delayed.

18. The navigation device of claim 17, wherein the operation of displaying the graphic object includes:
an operation of determining whether to display the graphic object based on a number of the navigation device and the at least one peer navigation device detected as being delayed; and
an operation of displaying the graphic object in response to determining that the graphic object is displayed.

19. The navigation device of claim 17, wherein the operation of displaying a graphic object further includes an operation of displaying a tag indicating delay information on any of the navigation device and the at least one peer navigation device detected as being delayed.

20. The navigation device of claim 17, wherein the instructions cause the processor to further perform an operation of displaying transmission information of the delay-related communication in response to selection of the graphic object.
